(19) United States
(12) Patent Application Publication
(10) Pub. No.: US 2009/0311365 A1
(43) Pub. Date: Dec. 17, 2009

(54) High omega-3 saturated fat free red meat products

(76) Inventor: Michael M. Means, Topeka, KS (US)

Correspondence Address: JAMES RAY & ASSOCIATES, 2640 PITCAIRN ROAD, MONROEVILLE, PA, 15146, US

(21) Appl. No.: 12/157,855

(22) Filed: Jun. 13, 2008

(51) Int. Cl. A23L 1/31; A23L 1/315

(52) U.S. Cl. 426/2; 426/480

(57) ABSTRACT

A method for producing substantially fat free beef without any saturated fat contained therein. The method comprises the steps of selecting a breed of extra lean cattle and a step of acquiring a predetermined number of the breed of extra lean beef cattle selected in the previous step. There is a step of cross breeding the breed of extra lean beef cattle acquired previously with Parthenais bulls that have been fed grass only so as to obtain extra lean cattle. There is a step of feeding such extra lean cattle derived from such cross breeding with all natural grass only and a step of taking hand selected meat cuts from the all natural grass fed cattle and a step of grinding up the hand selected meat cuts from the previous step and then a step of mixing such ground up meat cuts with a predetermined amount of one of olive oil and canola oil to produce a high omega-3, saturated fat free product.

### FIELD OF THE INVENTION

The present invention relates, in general, to a meat product, and, more particularly, the present invention relates primarily to a high omega fat free ground beef without saturated fat and to related red meat products as well as other meat products.

### BACKGROUND OF THE INVENTION

In today's society there is growing concern with individuals consuming a large amount of fat from many of the meat products. There is even more concern that the fat consumed contains high quantities of saturated fat. Saturated fat and trans fat are considered “bad” fats. Saturated fats are found mainly in animal products such as meats; poultry (mostly in dark meat and skin); whole and partially skimmed dairy products as well as lard. Eating too much of the saturated fats seems to be directly related to the high cholesterol levels which are found in a large percentage of the population. Doctors are very concerned with means of reducing these cholesterol levels and in many cases have used medication to lower the levels.

Red meat has been considered a culprit in producing the high cholesterol levels to the point that it is suggested that consumers eat only one or two red meat dishes a week and to not provide more than 10% of the total calories.

There is another problem in regard to fats; however, this is a different type of problem. This is problem that corresponds to a lack of omega-3 oils in most peoples diets. It does not appear to be a problem in cultures where fish seems to be a staple of the diet since fish contains omega-3 oil, and also cultures where olive oil is frequently used since olive oil also contains omega-3 oil. Saturated fats have only single bonds in the carbon backbone, whereas, omega-3 is a long chain mono unsaturated fatty acid and omega-6 fatty acids are long chained, polyunsaturated fatty acids having two or more double bonds and are the building blocks of triglycerides and other lipids. These fatty acids (omega-3 and omega-6) are important because our bodies do not have the ability to create double bonds after the tenth carbon from the carboxyl group. Thus, oleic, linoleic and linolenic fatty acids are essential. However, the omega-3 seems to be much more important because the omega-6 fatty acids, although necessary, do not provide all the health benefits that are found in omega-3 fatty acids. Thus, it would be advantageous if there were a red meat product that would not only be low in fat content but also free of saturated fats and provide a source of omega-3 fatty acids.

### SUMMARY OF THE INVENTION

In a first aspect the present invention provides a method for producing substantially fat free beef without any saturated fat contained therein. The method comprises the steps of selecting a breed of extra lean cattle and a step of acquiring a predetermined number of the breed of extra lean beef cattle selected in the previous step. There is a step of cross breeding the breed of extra lean beef cattle acquired previously with Parthenais bulls that have been fed grass only so as to obtain extra lean cattle. There is a step of feeding the extra lean cattle derived from such cross breeding with all natural grass only and a step of taking hand selected meat cuts from the all natural grass fed cattle from a previous step and a step of grinding up the hand selected meat cuts from the previous step and then a step of mixing such ground up meat cuts with a predetermined amount of one of olive oil and canola oil to produce a high omega-3, saturated fat free product.

In a second aspect the present invention provides a method for producing low fat pork products containing a minimum of saturated fat. The method comprises the steps of taking hand selected pork cuts and then removing all visible and discernable fat from the hand selected pork cuts. There is a step of removing any visible sinew from the hand selected pork cuts. This is followed by grinding up the hand selected pork cuts from the previous step and then mixing the ground up pork cuts from the previous step with a predetermined amount of one of olive oil and canola oil to produce a high omega-3, low fat product.

In a third aspect the present method provides a method for producing low fat poultry products containing a minimum of saturated fat. Such method comprises the steps of taking hand selected breast portions of poultry and a step of removing all skin from the hand selected breast portions of poultry from the previous step and then a step of removing all visible and discernable fats and sinew from such hand selected breast portions. There is a step of grinding up the skin free poultry product and then mixing the ground up poultry product from the previous step with a predetermined amount of olive and canola oils.

### OBJECTS OF THE INVENTION

It is, therefore, one of the primary objects of the present invention to provide a red meat product that is free of saturated fats.

Another object of the present invention is to provide a red meat product that is extra lean.

Still another object of the present invention is to provide a red meat product that is derived from cattle that have been only grass fed.

Yet another object of the present invention is to provide a red meat product from cattle that have never been fed any antibiotic based feed or any synthetic hormones.

Another object of the present invention is to cross breed extra lean beef cattle with Parthenais bulls to produce extra lean beef cattle.

Still another object of the present invention is to provide a red meat product that can be mixed with olive oil or canola oil to provide a product that is high in omega-3 fatty acids.

Yet another object of the present invention is to mix other meats, such as pork, turkey or chicken with such olive or canola oils to produce a product the is high in omega-3 fatty acids.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE PRESENTLY PREFERRED AND VARIOUS ALTERNATIVE EMBODIMENTS OF THE INVENTION

In a first aspect the present invention provides a method for producing substantially fat free beef without any saturated fat contained therein, such method comprising the steps of selecting a breed of extra lean cattle followed by a step of acquiring a predetermined number of such breed of extra lean beef cattle selected in the previous step. There is a step of cross breeding the breed of extra lean beef cattle acquired previously with Parthenais bulls that have been fed grass only so as to obtain extra lean cattle. There is a step of feeding such extra lean cattle derived from such cross breeding with all natural grass only and a step of taking hand selected meat cuts from the all natural grass fed cattle derived from a previous step and a step of grinding up the hand selected meat cuts from the previous step and then a step of mixing such ground up meat cuts with a predetermined amount of one of olive oil and canola oil to produce a high omega-3, saturated fat free product.

The method further includes a step of preparing one of sausage, hamburger, meat loaf, hot dogs, bratwurst, jerky, all beef bologna, and all beef sandwich meats from the product that was mixed with one of olive oil and canola oil produced in a previous step.

The method further includes a step of packaging such one of sausage, hamburger, meat loaf, hot dogs, bratwurst, jerky, all beef bologna, and all beef sandwich meats from the product that was mixed with one of olive oil and canola oil in a previous step.

There is also a step of mixing a predetermined amount and a predetermined type of seasoning to the product prepared in a previous step in producing one of sausage, hamburger, meat loaf, hot dogs, bratwurst, jerky, all beef bologna and all beef sandwich meats.

The method includes a step of selecting the breed of extra lean beef cattle from at least one of Limousin, Charolais, Salair, Belgian Blue, Piedmontese and Texas Longhorn. It is presently preferred that such breed of extra lean beef selected in the first step is the breed of Limousin cattle.

It should be noted that great care is taken to ensure that the extra lean breed product prepared in a previous step is free of saturated fats. The fats that are present in the final product are essentially derived from the olive or canola oils used to mix with the ground beef. These fats are primarily mono-unsaturated fats and polyunsaturated fats which are considered “good” fats and desirable to have.

It should be noted that although the present invention is primarily related to beef products it is within the concept of the invention that other meats such as pork, chicken or turkey can also be modified by the present invention. As is done with beef where all visual or discernable evidence of fat is stripped from the meat along with any visible sinew, the same is done with other meats.

Thus, in the case of pork where again one would take the leanest pork cuts available and then trim them so as to carefully remove all visible or discernable fat from the meat as well as removing any sign of sinew. This trimmed meat is then ground up as was done with the beef product. The ground up lean pork is then mixed with a predetermined amount of either olive or canola oils. The mixed product is then formed into whatever product is desired, such as pork burgers, breakfast sausage (link and patty), summer sausage, all pork bologna, and other pork sandwich meats, all pork hot dogs, brats and polish sausages (smoked or cured). The method produces low fat pork products that are high in omega-3 fatty acids.

Similarly, chicken or turkey could also be treated as was done with pork. Most of the fat in turkey and chicken resides in the skin portion and also the dark meat portion of the bird. So, in this case one would carefully remove the skin from the turkey or chicken breast portions and also remove any visible or discernable fat (or any sinew) that might also be present. The breast portions would then be ground up and the product mixed with a predetermined amount of olive or canola oil. This treated product can then be made into whatever type of product is desired. Again, this is a product that is essentially fat free with a minimum of saturated fat and a product that is high in omega-3 fatty acids.

As described supra where it is shown that the present invention is not only applicable to beef products but can also be used with pork or poultry it is still within the concept of the invention that such method would also be applicable to lamb or mutton or any other meat product.

As stated previously the method is primarily designed for producing essentially fat free beef products although as, again stated previously it is applicable for use with other meats.

It should be mentioned that the government regulations state that any 3 ounce serving of meat that contains less than ½ gram of fat is considered to be fat free.

To repeat the process starts with acquiring special breeds of cattle that are extra lean, such as a Limousin breed, and cross breeding that breed with Parthenais bulls that have been raised only on grass. The Parthenais bulls have never been fed synthetic hormones or given antibiotic feed of any kind.

Essentially, the only fat in the products that are prepared from meat from the cross bred cattle that have been bred for low fat content (and have been fed only grass) comes from the olive or canola oils that are added to the ground up product. Both of these oils are essentially free of saturated fats. Olive oil contains mono-unsaturated fatty acids (oleic acid) and also contain powerful antioxidants which are chemicals that fight cancer. Canola oil contains primarily mono-unsaturated fatty acids (about 55%) but also contains significant quantities of polyunsaturated fatty acids (linoleic and linolenic acids) and is also essentially free of saturated fatty acids.

The lean beef products made from red meat derived from such grass fed cattle are ground meats for making hamburgers, ground steak, breakfast sausage (link and patty), summer sausage, jerky, all beef bologna, and other beef sandwich meats, all beef hot dogs, brats and polish sausages (smoked or cured). The ground meat is so lean that it will not stick together by itself but is mixed with a predetermined amount of olive oil and/or canola oil. Both of these oils are extremely high in fats that are omega-3 based and do not contain any saturated fats.

It should be noted that the amount of oil added to ground beef varies depending upon the end use. That is, if the product is to be hamburger that is going to be fried then approximately 1½ teaspoons of oil is added to a pound of ground meat. Whereas if the hamburger is to be grilled then approximately 2¼ teaspoons of oil are added to a pound of ground beef. Similarly, if the product is to be a hot dog then between about 1¼ and 1½ teaspoons of oil are added to the ground beef. It should also be noted that sea salt is used in virtually all of the recipes in place of regular table salt. Molasses is also used instead of granulated sugar in the recipes. All of this is done to make the final product not only more tasteful but more suitable for persons who may be diabetic, have heart problems or have high cholesterol or any combination of these ailments.

The new product will allow hospitals to serve fat free foods to patients in the form of red meat without having any saturated fats in the foods. This would be very beneficial to diabetics, cancer patients, heart patients etc. Further, such products would allow restaurants and steak houses to serve low fat healthy red meat to customers that cannot eat red meat any more because of the saturated fat content. It would allow grocery stores, health food stores, deli's etc. to sell products to a large growing segment of our population who have serious health issues that have a need for products such as these that are presently not available anywhere.

This product is a saturated fat free product that is made with from extremely low fat beef that is mixed with a small percentage of a fat from olive or canola oil so as to provide the fats that are needed for a persons health.

The present invention takes hand selected and trimmed cuts of all natural, grass fed, home raised and humanely cared for “Parthenais influenced beef cattle”, that have never been fed any antibiotic based feed nor have they been given any synthetic hormones, only grass for feed. This meat is then ground and mixed with olive or canola oils to make them into the products previously mentioned. Mixing with oil is not only needed to make the product adhere to itself for forming into patties or links or any such shape but also to provide the product with essential fatty acids needed by the body. These acids are omega-3 fatty acids.

The fat free beef is mixed with the omega 3-fats (oils) to make the various saturated fat free products. The new products are used the same manner or in recipes that would normally use beef that had the animals fats therein, such as sausage, hamburgers, meat loafs, hot dogs, bratwurst, etc. There is seasoning added in the forming many of the above listed products. The seasoning would be similar to the seasoning presently used to make these products with regular fatted beef.

At present there are no other products that are made with red meat that have zero saturated fat. The product has been approved by “Cancer Treatment Centers of America” as products that are good for diabetic and cancer patients because cancer, diabetes and clogged arteries thrive on saturated fat and this product does not have any saturated fat.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. A method for producing substantially fat free beef without any saturated fat contained therein, said method comprising the steps of:
(a) selecting a breed of extra lean cattle;
(b) acquiring a predetermined number of said breed of extra lean beef cattle selected in step (a);
(c) cross breeding said breed of extra lean beef cattle with Parthenais bulls that have been fed grass only to obtain extra lean cattle;
(d) feeding said extra lean cattle derived from said cross breeding in step (c) with all natural grass only;
(e) taking hand selected meat cuts from said all natural grass fed cattle from step (c);
(f) grinding up said hand selected meat cuts from step (d); and
(g) mixing said ground up meat cuts from step (e) with a predetermined amount of one of olive oil and canola oil to produce a high omega-3, saturated fat free product.

2. The method, according to claim 1, wherein said method further includes a step of preparing one of sausage, hamburger, meat loaf, hot dogs, bratwurst, jerky, all beef bologna, and all beef sandwich meats from said product mixed with one of olive oil and canola oil produced in step (g).

3. The method, according to claim 2, wherein said method further includes a step of packaging said one of sausage, hamburger, meat loaf, hot dogs, bratwurst, jerky, all beef bologna, and all beef sandwich meats from said product mixed with one of olive oil and canola oil produced in step (g).

4. The method, according to claim 2, wherein said method further includes a step of mixing a predetermined amount and a predetermined type of seasoning to said product prepared in step (f) to produce one of sausage, hamburger, meat loaf, hot dogs, bratwurst, jerky, all beef bologna, and all one of sausage, hamburger, meat loaf, hot dogs, bratwurst, jerky, all beef bologna, and all beef sandwich meats.

5. The method, according to claim 1, wherein said method further includes a step of selecting said breed of extra lean beef cattle from at least one of Limousin, Charolais, Salair, Belgian Blue, Piedmontese and Texas Longhorn in step (a).

6. The method, according to claim 5, wherein said method further includes the step of selecting such extra lean beef cattle from Limousin cattle in step (a).

7. The method, according to claim 1, wherein said method further includes a step of ensuring that said product prepared in step (g) is free of saturated fats.

8. A method for producing low fat pork products containing a minimum of saturated fat, said method comprising the steps of:
(a) taking hand selected pork cuts;
(b) removing all visible and discernable fat from said hand selected pork cuts;
(c) removing any visible sinew from said hand selected pork cuts;
(d) grinding up said hand selected pork cuts from step (c);
(e) mixing said ground up pork cuts from step (d) with a predetermined amount of one of olive oil and canola oil to produce a high omega-3, low fat product.

9. The method, according to claim 8, wherein said method further includes a step of forming said ground up pork mixed with one of olive and canola oil into one of pork burgers, breakfast sausage (link and patty), summer sausage, all pork bologna, and other pork sandwich meats, all pork hot dogs, brats and polish sausages.

10. A method for producing low fat poultry products containing a minimum of saturated fat, said method comprising the steps of:
(a) taking hand selected breast portions of said poultry;
(b) removing all skin from said hand selected breast portions of said poultry from step (a);
(c) removing all visible and discernable fats and sinew from said hand selected breast portions;
(d) grinding up said skin free poultry product from step (c);
(e) mixing said ground up poultry product from step (d) with a predetermined amount of one of olive and canola oils to produce a high omega-3, low fat product.

11. The method, according to claim 10, wherein said poultry is selected from one of chicken and turkey.

12. The method, according to claim 11, wherein said method includes the step of forming said product from step (e) into one of turkey burgers, turkey sausage and turkey sandwich meats.
